(19) United States
(12) Patent Application Publication
(10) Pub. No.: US 2022/0110307 A1
(43) Pub. Date: Apr. 14, 2022

(54) CONDUCTIVE TERMITE BAIT SYSTEM

(71) Applicant: Ningbo Usun Product Design Co., Ltd, Ningbo (CN)

(72) Inventor: Wenguo Ge, Ningbo (CN)

(21) Appl. No.: 17/069,255

(22) Filed: Oct. 13, 2020

(51) Int. Cl. A01M 1/02

(52) U.S. Cl. CPC A01M 1/026; A01M 2200/011

(57) ABSTRACT

The present disclosure includes a conductive termite bait device, including: a strip elongate along a first direction; a first insulative layer disposed along at least a portion of the strip; and a bait layer disposed between the first insulative layer and the strip. The bait layer may be configured to attract termites. In some embodiments, the first insulative layer and the bait layer are compressed to thereby bind the first insulative layer and the bait layer together.

### BACKGROUND

Termites are insects found throughout the world. Termites mostly feed on dead plant material and cellulose, generally in the form of wood, leaf litter, soil, or animal dung. Termites are major detritivores, particularly in the subtropical and tropical regions, and their recycling of wood and plant matter is of considerable ecological importance.

Owing to their wood-eating habits, many termite species can do significant damage to unprotected buildings and other wooden structures. Termites play an important role as decomposers of wood and vegetative material, and the conflict with humans occurs where structures and landscapes containing structural wood components, cellulose derived structural materials and ornamental vegetation provide termites with a reliable source of food and moisture. Their habit of remaining concealed often results in their presence being undetected until the timbers are severely damaged, with only a thin exterior layer of wood remaining. In addition to causing damage to buildings, termites can also damage food crops. Termites may attack trees whose resistance to damage is low but generally ignore fast-growing plants.

The damage caused by termites is extensive and humans respond in a variety of ways to control the intrusion of termites in unwanted places. Structures may be homes or business, or elements such as wooden fence posts and telephone poles. Regular and thorough inspections by a trained professional may be necessary to detect termite activity. Systems and equipment can also be used to detect and/or eliminate termites.

### SUMMARY

This disclosure includes a conductive termite bait device, including: a strip elongate along a first direction; a first insulative layer disposed along at least a portion of the strip; and a bait layer disposed between the first insulative layer and the strip, the bait layer configured to attract termites. The first insulative layer and the bait layer are compressed to thereby bind the first insulative layer and the bait layer together. In some embodiments, the bait layer comprises cellulose.

The conductive termite bait device may include a first conductive layer disposed between the bait layer and the first insulative layer, the first conductive layer configured to increase in conductivity as the first conductive layer is consumed by termites. The first conductive layer, the first insulative layer, and the bait layer may be compressed to thereby bind the first conductive layer, the first insulative layer, and the bait layer together.

In some embodiments, the bait layer is impregnated with conductive material configured to increase in conductivity as the bait layer is consumed by termites.

In some embodiments, the device includes a second insulative layer disposed between the bait layer and the strip such that the second insulative layer physically contacts the strip. The first insulative layer, the second insulative layer, and the bait layer may be compressed to thereby bind the first insulative layer, the second insulative layer, and the bait layer together.

In some embodiments, the device includes a second conductive layer disposed over the first conductive layer, the second conductive layer configured to increase in conductivity as the second conductive layer is consumed by termites. The first conductive layer, the second conductive layer, the first insulative layer, and the bait layer may be compressed to thereby bind the first conductive layer, the second conductive layer, the first insulative layer, and the bait layer together.

In some embodiments, the second conductive layer is disposed between the first conductive layer and the first insulative layer. In some embodiments, the device includes a second conductive layer that physically contacts the first conductive layer. In some embodiments, the first conductive layer is permeable and the second conductive layer is permeable.

In some embodiments, the device includes a third conductive layer disposed over the second conductive layer, the third conductive layer configured to increase in conductivity as the third conductive layer is consumed by termites. The first conductive layer, the second conductive layer, the third conductive layer, the first insulative layer, and the bait layer may be compressed to thereby bind the first conductive layer, the second conductive layer, the third conductive layer, the first insulative layer, and the bait layer together.

In some embodiments, the device includes a third conductive layer disposed between the second conductive layer and the first insulative layer. In some embodiments, the third conductive layer physically contacts the second conductive layer.

Some embodiments include a fourth conductive layer disposed over the third conductive layer, the fourth conductive layer configured to increase in conductivity as the fourth conductive layer is consumed by termites. The first conductive layer, the second conductive layer, the third conductive layer, the fourth conductive layer, the first insulative layer, and the bait layer may be compressed to thereby bind the first conductive layer, the second conductive layer, the third conductive layer, the fourth conductive layer, the first insulative layer, and the bait layer together.

In some embodiments, the fourth conductive layer is disposed between the third conductive layer and the first insulative layer and the fourth conductive layer may physically contact the third conductive layer.

In some embodiments, the first insulative layer is impregnated with cellulose, the second insulative layer is impregnated with cellulose, the first conductive layer is impregnated with cellulose, the second conductive layer is impregnated with cellulose, the third conductive layer is impregnated with cellulose, and the fourth conductive layer is impregnated with cellulose.

In some embodiments, the first insulative layer, the second insulative layer, the bait layer, the first conductive layer, the second conductive layer, the third conductive layer, and the fourth conductive layer define a first portion that extends along the first direction. The first insulative layer, the second insulative layer, the bait layer, the first conductive layer, the second conductive layer, the third conductive layer, and the fourth conductive layer may define a second portion that extends along a second direction perpendicular to the first direction. In some embodiments, the first portion and the second portion are contiguous to each another.

In some embodiments, the first insulative layer, the second insulative layer, the bait layer, the first conductive layer, the second conductive layer, the third conductive layer, and the fourth conductive layer define a third portion that extends along the first direction. The third portion may be offset from the first portion along the second direction. In some embodiments, the second portion and the third portion are contiguous to each another.

In some embodiments, the first insulative layer, the second insulative layer, the bait layer, the first conductive layer, the second conductive layer, the third conductive layer, and the fourth conductive layer define a fourth portion that extends along the second direction. In some embodiments, the third portion and the fourth portion are contiguous to each another.

The first insulative layer, the second insulative layer, the bait layer, the first conductive layer, the second conductive layer, the third conductive layer, and the fourth conductive layer may define a fifth portion that extends along the first direction. The fifth portion may be offset from the third portion. In some embodiments, the fifth portion is substantially aligned with the first portion along the second direction. In some embodiments, the fourth portion and the fifth portion are contiguous to each another.

The first insulative layer, the second insulative layer, the bait layer, the first conductive layer, the second conductive layer, the third conductive layer, and the fourth conductive layer may define a first terminal portion that extends along the first direction and the second direction and is located adjacent a first end of the strip. The first insulative layer, the second insulative layer, the bait layer, the first conductive layer, the second conductive layer, the third conductive layer, and the fourth conductive layer may define a second terminal portion that extends along the first direction and the second direction and is located adjacent a second end of the strip located opposite the first end. In some embodiments, the device further includes a first electrical terminal electrically coupled to at least one of the first conductive layer and disposed within the first terminal portion; and a second electrical terminal electrically coupled to at least one of the first conductive layer and disposed within the second terminal portion

### BRIEF DESCRIPTION OF THE DRAWINGS

These and other features, aspects, and advantages are described below with reference to the drawings, which are intended to illustrate, but not to limit, the invention. In the drawings, like reference characters denote corresponding features consistently throughout similar embodiments. Various components in the drawings may not be drawn to scale.

FIG. 1a shows an example system of termite bait stations located around a building, according to some embodiments.

FIG. 1b shows an example system of termite bait stations and schematic of a control unit, according to some embodiments.

FIG. 2 shows an individual termite bait station with termite bait disposed within, according to some embodiments.

FIG. 3a shows another example system of termite bait stations located within a building, according to some embodiments.

FIG. 3b shows an example system including a plurality of termite bait stations communicatively coupled to a programmable micro controller, according to some embodiments.

FIG. 3c shows another example system including a plurality of termite bait stations communicatively coupled to a programmable micro controller, according to some embodiments.

FIG. 4 show an embodiment of a bait strip, according to some embodiments.

FIG. 5 show another embodiment of a bait strip, according to some embodiments.

FIG. 6 show another embodiment of a bait strip, according to some embodiments.

FIG. 7 shows a view of an end portion of a bait strip, according to some embodiments.

FIG. 8 shows a view of an end portion of another bait strip, according to some embodiments.

FIG. 9 shows a view of an end portion of another bait strip, according to some embodiments.

FIG. 10 shows an embodiment of a bait strip, according to some embodiments.

FIG. 11 shows another embodiment of a bait strip, according to some embodiments.

FIG. 12 shows another embodiment of a bait strip, according to some embodiments.

FIG. 13 shows another embodiment of a bait strip, according to some embodiments.

FIG. 14 shows another embodiment of a bait strip, according to some embodiments.

FIG. 15 shows another embodiment of a bait strip, according to some embodiments.

### DETAILED DESCRIPTION

Although certain embodiments and examples are disclosed below, inventive subject matter extends beyond the specifically disclosed embodiments to other alternative embodiments and/or uses, and to modifications and equivalents thereof. Thus, the scope of the claims appended hereto is not limited by any of the particular embodiments described below. For example, in any system or method disclosed herein, the acts or operations of the system or method may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, methods, and/or procedures described herein may be embodied as integrated components or as separate components.

For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

### Component Index

1—Bait station system
2—Bait station
10—Bait strip
12—Strip
14—First insulative layer
16—Bait layer
18—First conductive layer
20—Second insulative layer
22—Second conductive layer
24—Third conductive layer
26—Fourth conductive layer
28—First portion
30—Second portion
32—Third portion
34—Fourth portion
36—Fifth portion
38—First terminal portion
40—First end
42—Second terminal portion
44—Second end
46—First electrical terminal
48—Second electrical terminal
50—First wire
52—Second wire
54—Interrogator
56—Control unit
57—Micro controller
58—Interface
59—First wireless communication
60—Processor
61—Second wireless communication
62—Memory
63—Indicator light

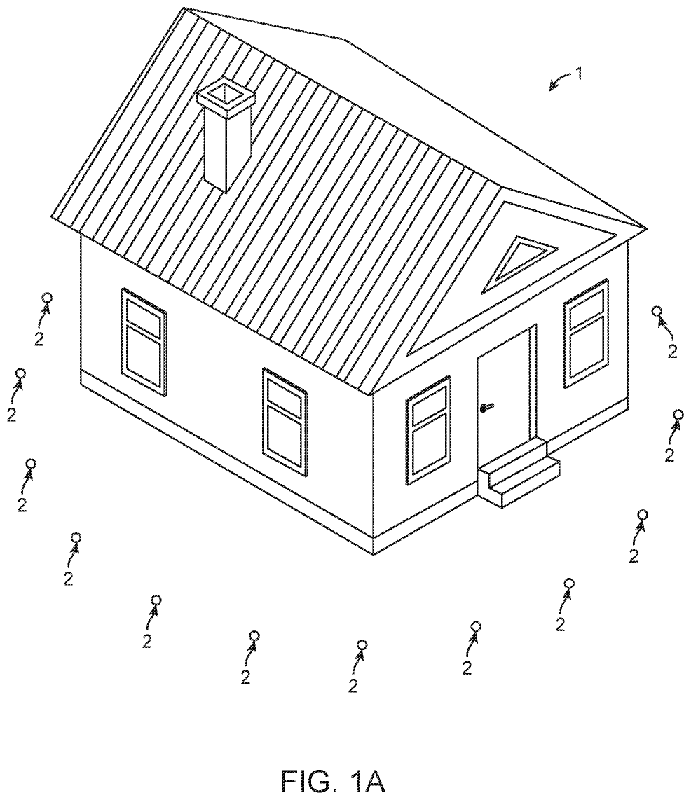

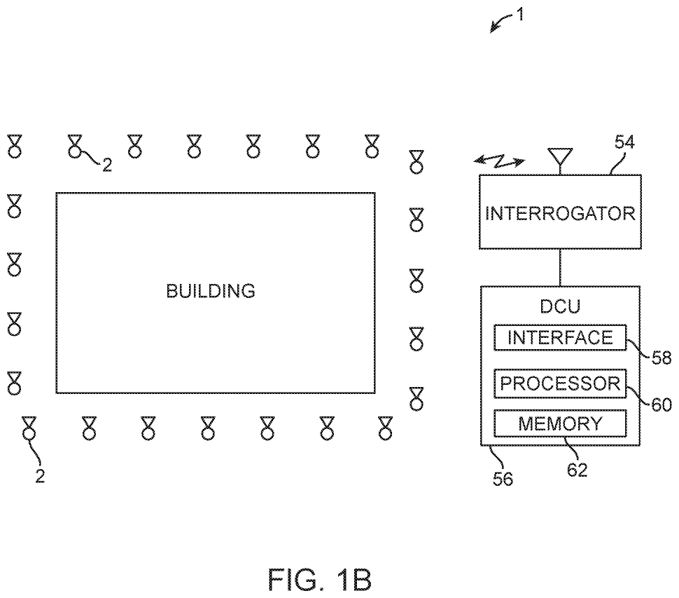

FIG. 1a shows a system (1) that includes a plurality of bait stations (2) surrounding a building. The building is representative and could be substituted by any asset that is a target for termites such as a field or piece of equipment. The bait stations (2) are positioned in such a manner that they are likely to come in contact with termites if termites are present.

FIG. 1b shows a system of bait stations (1) made up of a plurality of bait stations (2) surrounding a building. A human inspector may check the status of the bait station (2) using electronic means such as an interrogator (54) coupled to a control unit (56) comprising an interface (58), processor (60), and memory (62).

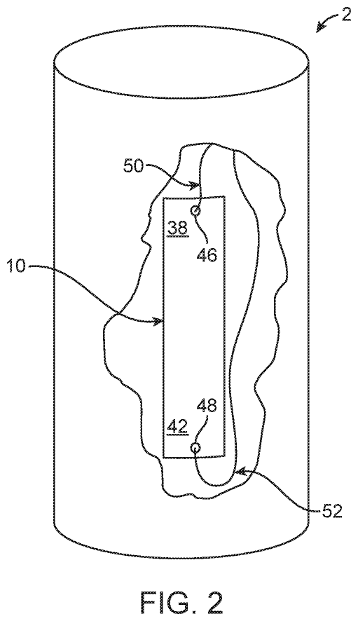

FIG. 2 shows a bait strip (10) disposed within a bait station (2). The bait strip (10) may be electrically connected to the bait station (10). In some embodiments, the bait strip (10) is connected to the bait station (2) via a first wire (50) and a second wire (52). The first wire (50) may be connected to a first electrical terminal (46) at the first terminal portion (38) and the second wire (52) is connected to a second electrical terminal (48) at the second terminal portion (42) of the bait strip (10).

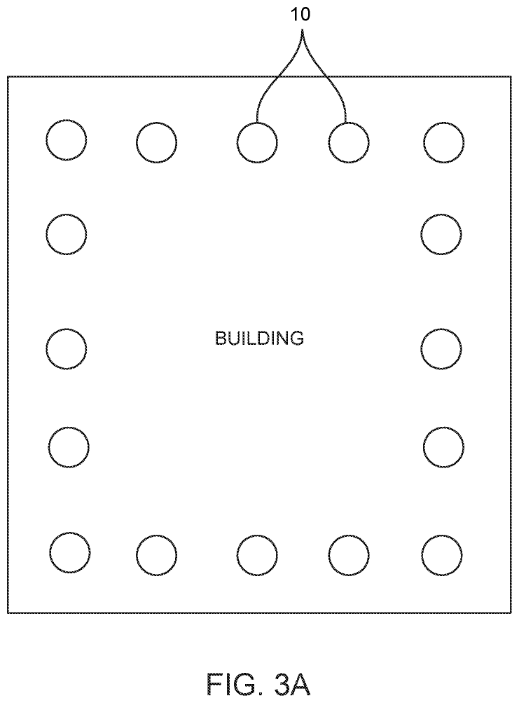

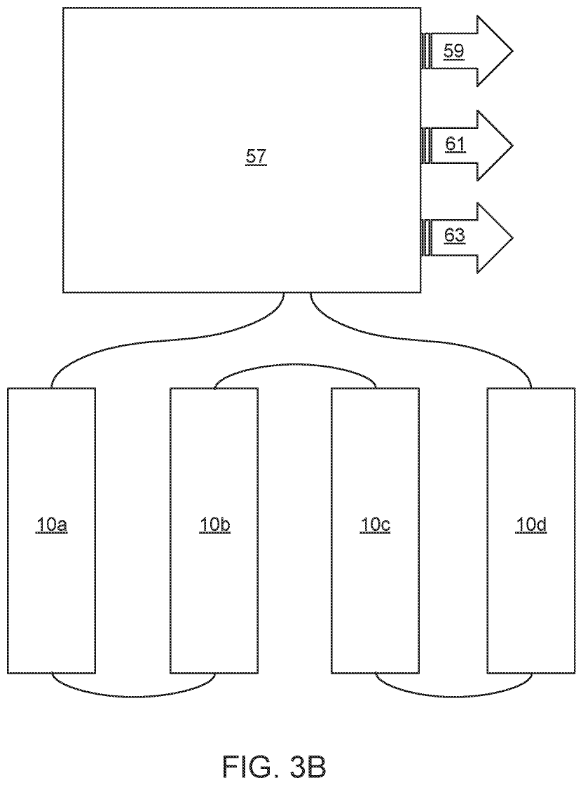

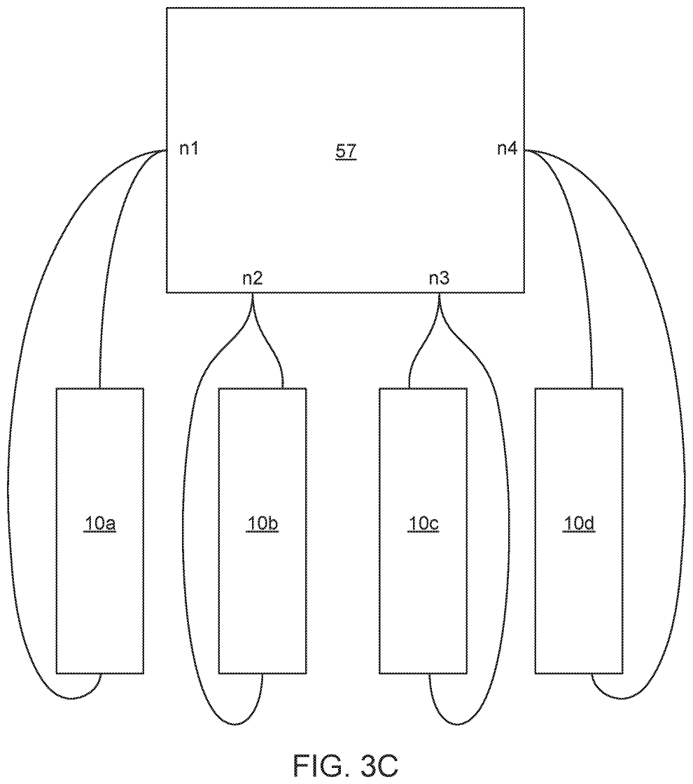

FIG. 3a shows another embodiment of a system (1) that includes a plurality of bait strips (10) located inside a building. As shown in FIG. 3b, the system (1) from FIG. 3a may include a plurality of bait strips (10a, 10b, 10c, and 10d), which are electrically and communicatively coupled to a programmable micro controller (57). The micro controller (57) may be configured to send a wired or wireless communication in response to one or more of the bait stations (2) being at least partially consumed by termites. Accordingly, the communication may serve as a notification regarding the presence of termites in or around the building. For example, as illustrated in FIG. 3b, the micro controller (57) may be arranged and configured to output a first wireless communication (59), which may comprise a cellular communication, such as a 3G, 4G, and/or 5G signal. The micro controller (57) may also be arranged and configured to output a second wireless communication (61), which may comprise a Bluetooth, RFID, and/or WiFi communication. Even still, the micro controller (57) may also be arranged and configured to illuminate an indicator light (63) in response to at least one of the bait strips (10) being at least partially consumed by termites.

As shown in FIG. 3b, the plurality of bait strips (10) may be coupled to the micro controller (57) in series via a wired connection. In this regard, when any of the bait strips (10) are consumed the micro controller (57) may only recognize that one of the bait strips (10) has been consumed, but the micro controller (57) may not be able to identify which strip precisely.

As shown in FIG. 3c, the system (1) may also be arranged in a different wire configuration whereby each of the bait strips (10a, 10b, 10c, and 10d) is electrically and communicatively coupled directly to the micro controller (57). In this regard, when termites have at least partially consumed any of the bait strips (10a, 10b, 10c, or 10d), the micro controller will be able to identify precisely which bait strip (10a, 10b, 10c, or 10d) has been at least partially consumed. Accordingly, the micro controller (57) may be able to transmit such information to a third party via first wireless communication (59), second wireless communication (61), and/or indicator light (63). As shown in FIG. 3c, the plurality of bait strips (10) may be coupled to the micro controller (57) in series via a wired connection. While not shown in FIG. 3c, the plurality of bait strips (10) may also be coupled to the micro controller (57) via a wireless connection that communicates via any wireless protocol disclosed herein.

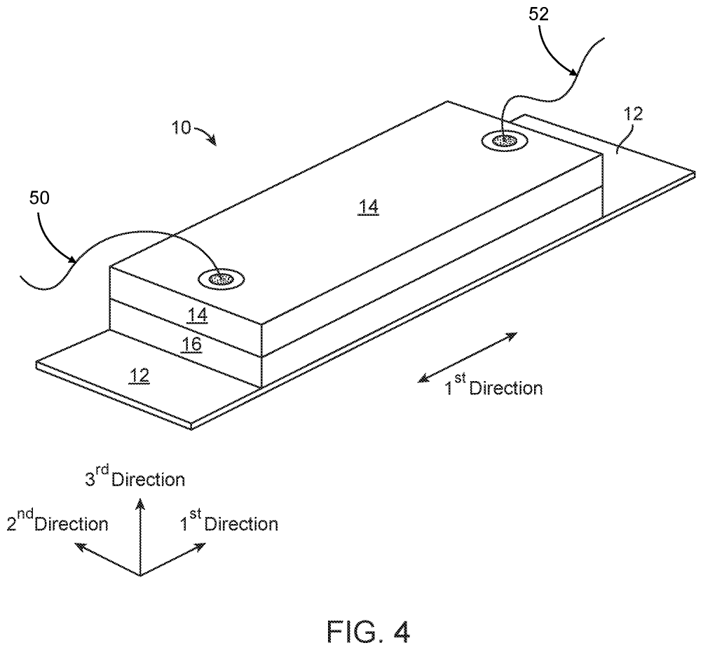

FIG. 4 shows an embodiment of the bait strip (10) comprising a strip (12) elongate along a first direction. The strip (12) may be constructed of but not limited to graphite, cellulose, and combinations thereof. In some embodiments, the cellulose is crop straw and a mixture of other plants, such as sugar cane bagasse, corn stover, rice husk, rice straw, wheat straw, timber, bamboo, reed, and the like. Above the strip (12) is a first insulative layer (14). In some embodiments the first insulative layer (14) is comprised of cellulose. The first insulative layer (14) could further or alternatively comprise, but is not limited to, conformal coating, insulating adhesive, insulating rubber, insulating plastic, glass, ceramic, mica, asbestos, any material that serves as a moisture barrier, and the like. There is a bait layer (16) disposed between the first insulative layer (14) and the strip (12) that is configured to attract termites. The first insulative layer (14) and the bait layer (16) may be compressed to bind the first insulative layer (14) and the bait layer (16) together. FIG. 4 also shows a first electrical terminal (46), first wire (50), a second electrical terminal (48), and second wire (52) for making an electrical connection.

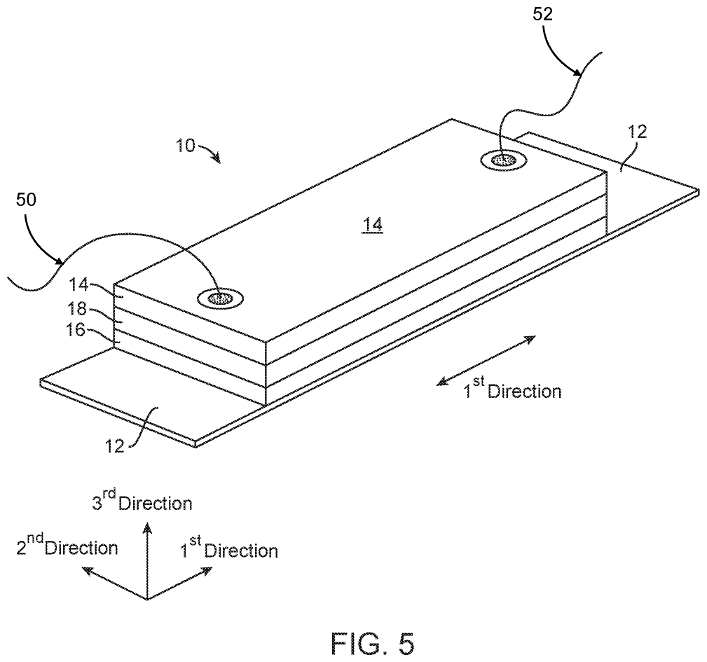

FIG. 5 shows an embodiment of the bait strip (10) including a first conductive layer (18) disposed between the bait layer (16) and the first insulative layer (14), the first conductive layer (18) configured to increase in conductivity as the first conductive layer is consumed by termites. As shown, the bait strip (10) is elongate along a first direction. The first conductive layer (18), the first insulative layer (14), and the bait layer (16) may be compressed to thereby bind the first conductive layer (18), the first insulative layer (14), and the bait layer (16) together. FIG. 5 also illustrates a first electrical terminal (46), first wire (50), a second electrical terminal (48), and second wire (52) for making an electrical connection.

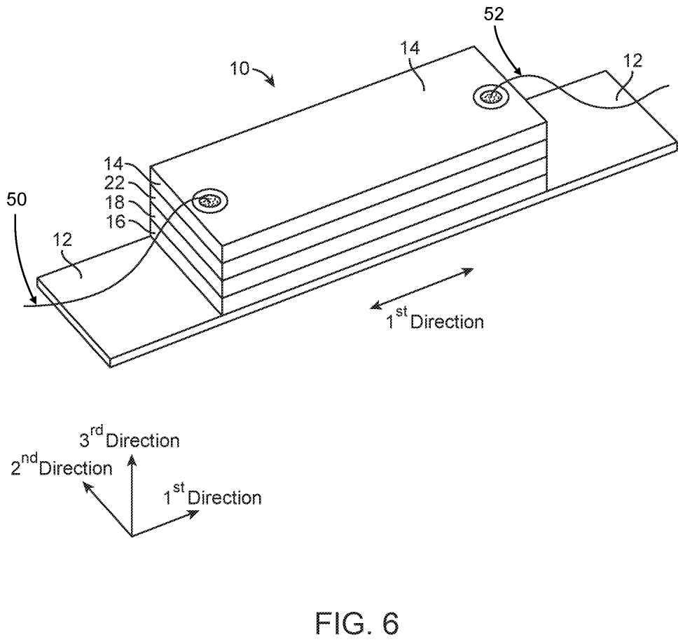

FIG. 6 shows an embodiment of the bait strip (10) comprising a second conductive layer (22) disposed over the first conductive layer (18), the second conductive layer (22) configured to increase in conductivity as the second conductive layer (22) is consumed by termites. In some embodiments, the first conductive layer (18), the second conductive layer (22), the first insulative layer (14), and the bait layer (16) are compressed to thereby bind the first conductive layer (18), the second conductive layer (22), the first insulative layer (14), and the bait layer (16) together. In some embodiments, the first conductive layer (18) and the second conductive layer (22) are permeable. As shown in FIG. 6, the bait strip (10) may include a first electrical terminal (46), first wire (50), a second electrical terminal (48), and second wire (52) for electrically connecting to the bait strip (10).

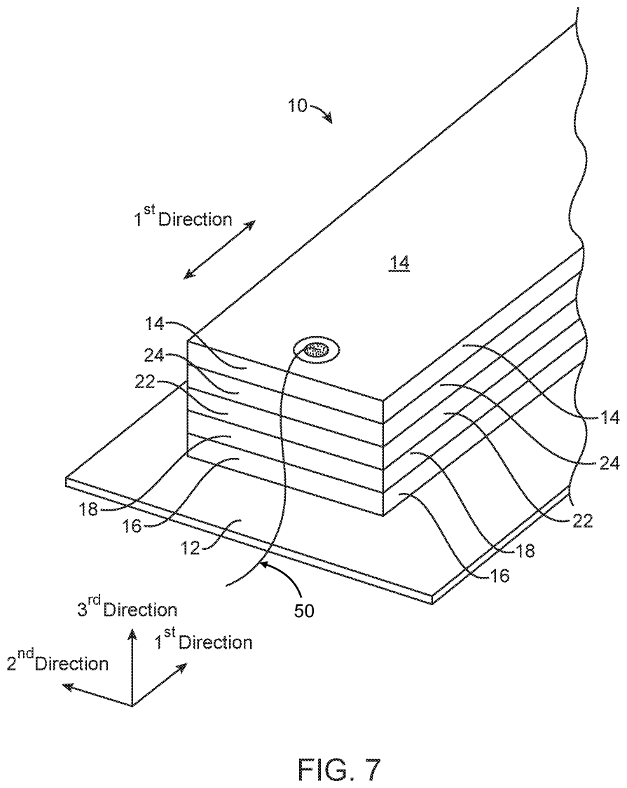

FIG. 7 shows an embodiment of the bait strip (10) comprising a third conductive layer (24) disposed over the second conductive layer (22), the third conductive layer (24) is configured to increase in conductivity as the third conductive layer (24) is consumed by termites. In some embodiments, the first conductive layer (18), the second conductive layer (22), the third conductive layer (24), the first insulative layer (14), and the bait layer (16) are compressed to thereby bind the first conductive layer (18), the second conductive layer (22), the third conductive layer (24), first insulative layer (14), and the bait layer (16) together. The figure also shows a first electrical terminal (46), first wire (50), a second electrical terminal (48), and second wire (52) for making an electrical connection.

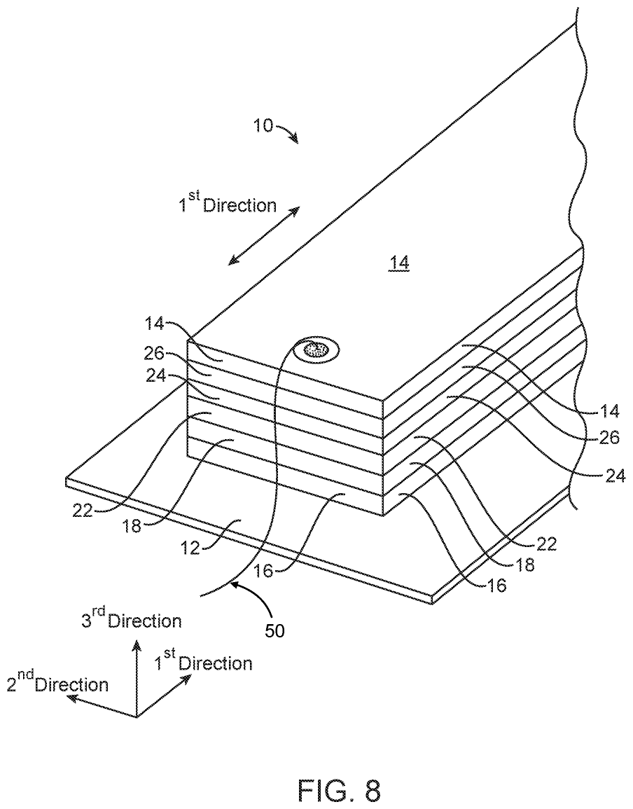

FIG. 8 shows an end view of an embodiment of the bait strip (10) comprising a fourth conductive layer (26) disposed over the third conductive layer (24). The fourth conductive layer (26) may be configured to increase in conductivity as the fourth conductive layer (26) is consumed by termites. In some embodiments, the first conductive layer (18), the second conductive layer (22), the third conductive layer (24), the fourth conductive layer (26), the first insulative layer (14), and the bait layer (16) are compressed to thereby bind the first conductive layer (18), the second conductive layer (22), the third conductive layer (24), the fourth conductive layer (26), first insulative layer (14), and the bait layer (16) together. As shown in FIG. 8, the bait strip (10) may also include a first electrical terminal (46), first wire (50), a second electrical terminal (48), and second wire (52) for making an electrical connection.

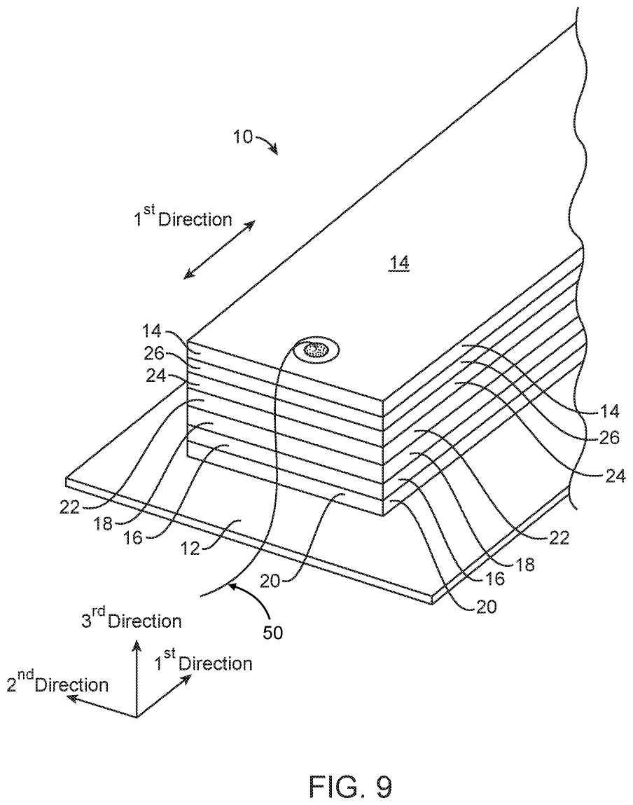

FIG. 9 shows an end view of an embodiment of the bait strip (10) comprising a second insulative layer (20) disposed between the bait layer (16) and the strip (12) such that the second insulative layer (20) physically contacts the strip (12). The first conductive layer (18), second insulative layer (20), the second conductive layer (22), the third conductive layer (24), the fourth conductive layer (26), the first insulative layer (14), and the bait layer (16) may be compressed to thereby bind the first conductive layer (18), the second conductive layer (22), the third conductive layer (24), the fourth conductive layer (26), first insulative layer (14), second insulative layer (20), and the bait layer (16) together. Additionally, the bait strip (10) may include a first electrical terminal (46), first wire (50), a second electrical terminal (48), and second wire (52) for establishing an electrical connection to the bait strip (10).

In many embodiments, any or all the following may be impregnated with cellulose: the first insulative layer (14), the second insulative layer (20), the first conductive layer (18), the second conductive layer (22), the third conductive layer (24), the fourth conductive layer (26), and the like.

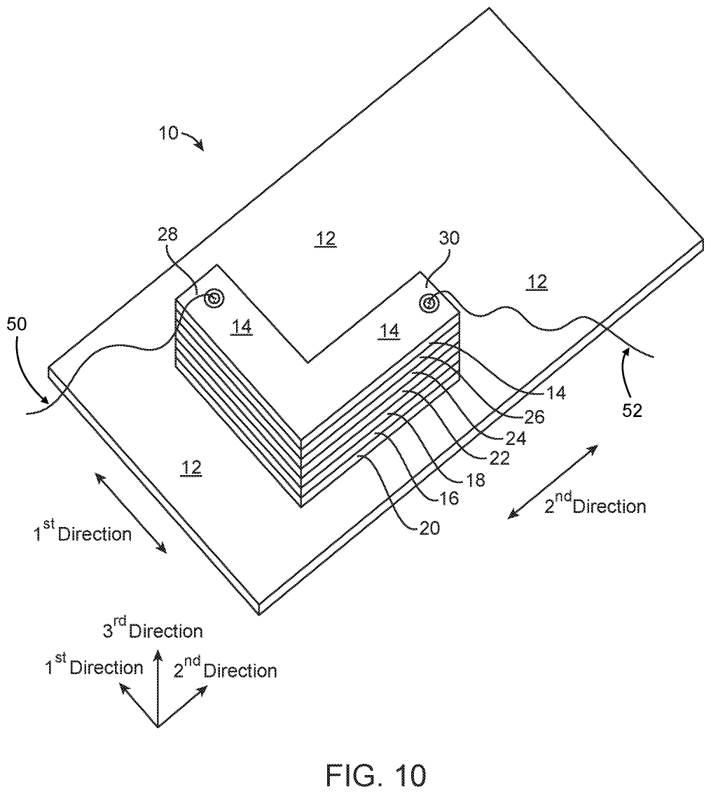

FIG. 10 shows a bait strip (10) whereby the first insulative layer (14), second insulative layer (20), bait layer (16), first conductive layer (18), second conductive layer (22), third conductive layer (24), and fourth conductive layer (26) define a first portion that extends along the first direction. The first insulative layer (14), second insulative layer (20), bait layer (16), first conductive layer (18), second conductive layer (22), third conductive layer (24), and fourth conductive layer (26) may define a second portion that extends along a second direction perpendicular to the first direction. The first portion and the second portion may be contiguous to each other. The figure also shows a first electrical terminal (46), first wire (50), a second electrical terminal (48), and second wire (52) for making an electrical connection.

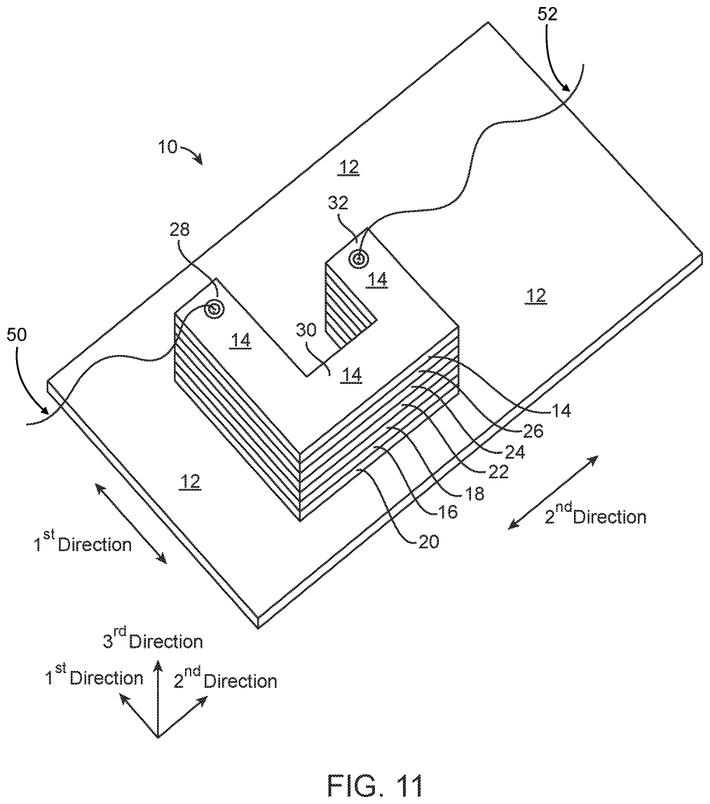

FIG. 11 shows a bait strip (10) whereby the first insulative layer (14), second insulative layer (20), bait layer (16), first conductive layer (18), second conductive layer (22), third conductive layer (24), and fourth conductive layer (26) define a first portion (28) that extends along a first direction, a second portion (30) that extends along a second direction, and a third portion (32) that extends along the first direction. The first portion (28) is contiguous with the second portion (30) and the second portion (30) is contiguous with the third portion (32). According to FIG. 11, the bait strip (10) may also include a first electrical terminal (46), first wire (50), a second electrical terminal (48), and second wire (52) for making an electrical connection.

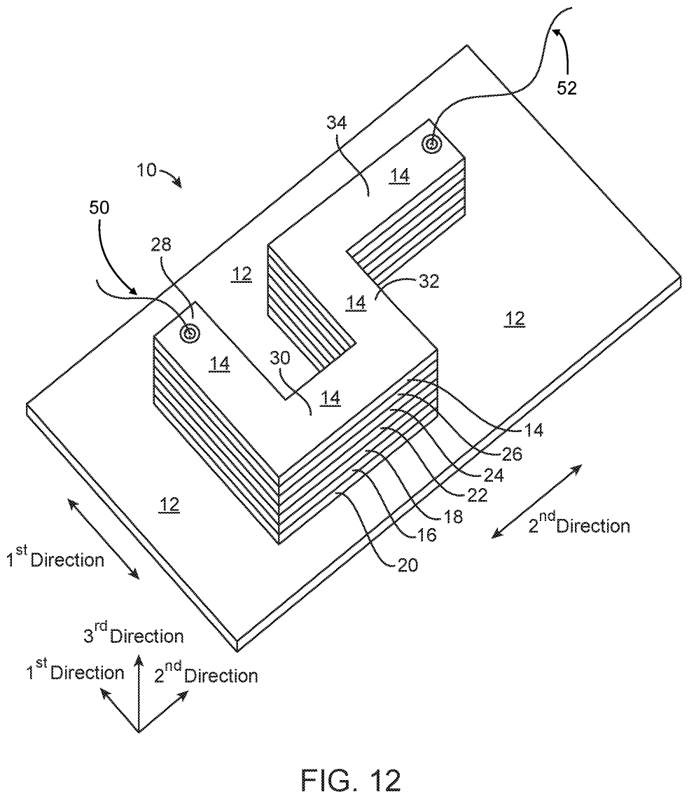

FIG. 12 shows a bait strip (10) whereby the first insulative layer (14), second insulative layer (20), bait layer (16), first conductive layer (18), second conductive layer (22), third conductive layer (24), and fourth conductive layer (26) define a first portion (28) that extends along a first direction, a second portion (30) that extends along a second direction, a third portion (32) that extends along the first direction, and a fourth portion (34) that extends along the second direction. In some embodiments, the first portion (28) is contiguous with the second portion (30), the second portion (30) is contiguous with the third portion (32), and the third portion (32) is contiguous with the fourth portion (34). As shown in FIG. 12, the bait strip (10) may also include a first electrical terminal (46), first wire (50), a second electrical terminal (48), and second wire (52) for making an electrical connection.

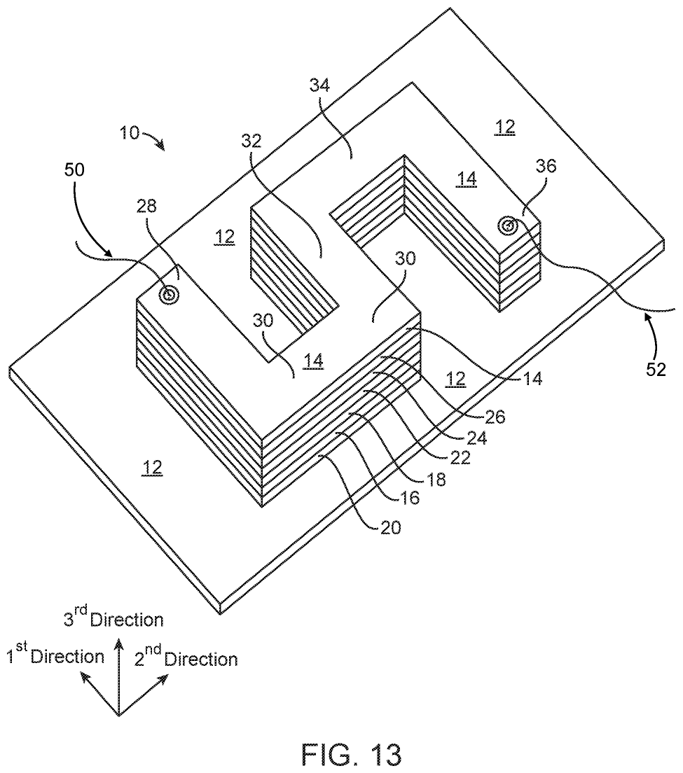

FIG. 13 shows a bait strip (10) whereby the first insulative layer (14), second insulative layer (20), bait layer (16), first conductive layer (18), second conductive layer (22), third conductive layer (24), and fourth conductive layer (26) define a first portion (28) that extends along a first direction, a second portion (30) that extends along a second direction, a third portion (32) that extends along the first direction, a fourth portion (34) that extends along the second direction, and a fifth portion (36) that extends along the first direction. The first portion (28) is contiguous with the second portion (30), the second portion (30) is contiguous with the third portion (32), and the third portion (32) is contiguous with the fourth portion (34). FIG. 13 also shows a first electrical terminal (46), first wire (50), a second electrical terminal (48), and second wire (52) for making an electrical connection.

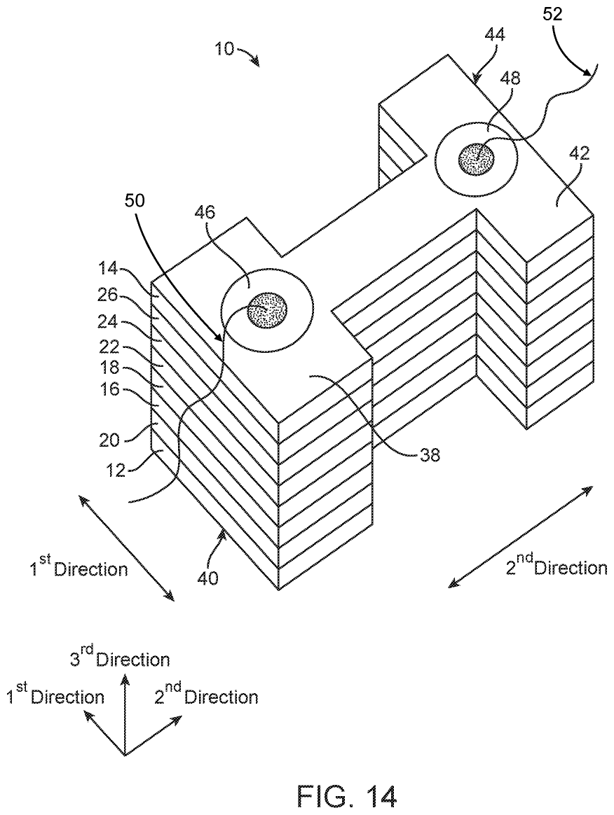

FIG. 14 shows a bait strip (10) whereby the first insulative layer (14), second insulative layer (20), bait layer (16), first conductive layer (18), second conductive layer (22), third conductive layer (24), and fourth conductive layer (26) define a first terminal portion (38) that extends along the first direction and the second direction and is located adjacent a first end of the strip (40). In some embodiments, the first insulative layer (14), second insulative layer (20), bait layer (16), first conductive layer (18), second conductive layer (22), third conductive layer (24), and fourth conductive layer (26) define a second terminal portion (42) that extends along the first direction and the second direction and is located adjacent a second end of the strip (44) located opposite the first end. FIG. 14 shows a first electrical terminal (46) electrically coupled to at least one of the first conductive layer (18) and disposed within the first terminal portion (38) and a second electrical terminal (48) electrically coupled to at least one of the first conductive layer (18) and disposed within the second terminal portion (42). The bait strip (10) may also include a first wire (50) and a second wire (52) for making an electrical connection.

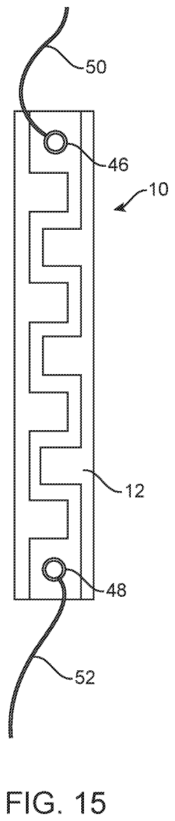

FIG. 15 shows an embodiment of a bait strip (10) whereby there are additional portions disposed along the strip (12). Those portions may comprise the first insulative layer (14), second insulative layer (20), bait layer (16), first conductive layer (18), second conductive layer (22), third conductive layer (24), and fourth conductive layer (26). These additional portions may be contiguous with at least one other portion and may lie in an orientation other than the first and second directions shown in FIGS. 10-13. FIG. 15 also shows a first electrical terminal (46), first wire (50), a second electrical terminal (48), and second wire (52) for making an electrical connection.

Although certain embodiments and examples are disclosed above, inventive subject matter extends beyond the specifically disclosed embodiments to other alternative embodiments and/or uses, and to modifications and equivalents thereof. Thus, the scope of the claims appended hereto is not limited by any of the particular embodiments described above. The structures, systems, methods, and/or devices described herein may be embodied as integrated components or as separate components. Furthermore, various omissions, substitutions, and changes in the form of the methods and systems described herein may be made without departing from the spirit of the inventions disclosed herein.

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1 and embodiments described in other sections may apply to and be combined with embodiments described within the “Topic 1” section.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment.

The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments can include A, B, and C. The term “and/or” is used to avoid unnecessary redundancy. Furthermore, the phrase “at least one of” may be used as a shorthand way of saying “and/or”. In this regard, the phrase “at least one of” may mean the same thing as “and/or.”

What is claimed is:

1. A conductive termite bait device, comprising:
a strip elongate along a first direction;
a first insulative layer disposed along at least a portion of the strip; and
a bait layer disposed between the first insulative layer and the strip, the bait layer configured to attract termites,
wherein the first insulative layer and the bait layer are compressed to thereby bind the first insulative layer and the bait layer together.

2. The device of claim 1, wherein the bait layer comprises cellulose.

3. The device of claim 1, further comprising a first conductive layer disposed between the bait layer and the first insulative layer, the first conductive layer configured to increase in conductivity as the first conductive layer is consumed by termites, wherein the first conductive layer, the first insulative layer, and the bait layer are compressed to thereby bind the first conductive layer, the first insulative layer, and the bait layer together.

4. The device of claim 1, wherein the bait layer is impregnated with conductive material configured to increase in conductivity as the bait layer is consumed by termites.

5. The device of claim 1, further comprising a second insulative layer disposed between the bait layer and the strip such that the second insulative layer physically contacts the strip, wherein the first insulative layer, the second insulative layer, and the bait layer are compressed to thereby bind the first insulative layer, the second insulative layer, and the bait layer together.

6. The device of claim 3, further comprising a second conductive layer disposed over the first conductive layer, the second conductive layer configured to increase in conductivity as the second conductive layer is consumed by termites, wherein the first conductive layer, the second conductive layer, the first insulative layer, and the bait layer are compressed to thereby bind the first conductive layer, the second conductive layer, the first insulative layer, and the bait layer together.

7. The device of claim 6, wherein the second conductive layer is disposed between the first conductive layer and the first insulative layer.

8. The device of claim 7, wherein the second conductive layer physically contacts the first conductive layer.

9. The device of claim 6, wherein the first conductive layer is permeable and the second conductive layer is permeable.

10. The device of claim 6, further comprising a third conductive layer disposed over the second conductive layer, the third conductive layer configured to increase in conductivity as the third conductive layer is consumed by termites, wherein the first conductive layer, the second conductive layer, the third conductive layer, the first insulative layer, and the bait layer are compressed to thereby bind the first conductive layer, the second conductive layer, the third conductive layer, the first insulative layer, and the bait layer together.

11. The device of claim 10, wherein the third conductive layer is disposed between the second conductive layer and the first insulative layer.

12. The device of claim 11, wherein the third conductive layer physically contacts the second conductive layer.

13. The device of claim 10, further comprising a fourth conductive layer disposed over the third conductive layer, the fourth conductive layer configured to increase in conductivity as the fourth conductive layer is consumed by termites, wherein the first conductive layer, the second conductive layer, the third conductive layer, the fourth conductive layer, the first insulative layer, and the bait layer are compressed to thereby bind the first conductive layer, the second conductive layer, the third conductive layer, the fourth conductive layer, the first insulative layer, and the bait layer together.

14. The device of claim 13, wherein the fourth conductive layer is disposed between the third conductive layer and the first insulative layer.

15. The device of claim 14, wherein the fourth conductive layer physically contacts the third conductive layer.

16. The device of claim 13, wherein the first insulative layer is impregnated with cellulose, the second insulative layer is impregnated with cellulose, the first conductive layer is impregnated with cellulose, the second conductive layer is impregnated with cellulose, the third conductive layer is impregnated with cellulose, and the fourth conductive layer is impregnated with cellulose.

17. The device of claim 13, wherein the first insulative layer, the second insulative layer, the bait layer, the first conductive layer, the second conductive layer, the third conductive layer, and the fourth conductive layer define a first portion that extends along the first direction,
wherein the first insulative layer, the second insulative layer, the bait layer, the first conductive layer, the second conductive layer, the third conductive layer, and the fourth conductive layer define a second portion that extends along a second direction perpendicular to the first direction, and
wherein the first portion and the second portion are contiguous to each another.

18. The device of claim 17, wherein the first insulative layer, the second insulative layer, the bait layer, the first conductive layer, the second conductive layer, the third conductive layer, and the fourth conductive layer define a third portion that extends along the first direction,
wherein the third portion is offset from the first portion along the second direction, and
wherein the second portion and the third portion are contiguous to each another.

19. The device of claim 18, wherein the first insulative layer, the second insulative layer, the bait layer, the first conductive layer, the second conductive layer, the third conductive layer, and the fourth conductive layer define a fourth portion that extends along the second direction, and
wherein the third portion and the fourth portion are contiguous to each another.

20. The device of claim 19, wherein the first insulative layer, the second insulative layer, the bait layer, the first conductive layer, the second conductive layer, the third conductive layer, and the fourth conductive layer define a fifth portion that extends along the first direction,
wherein the fifth portion is offset from the third portion,
wherein the fifth portion is substantially aligned with the first portion along the second direction, and
wherein the fourth portion and the fifth portion are contiguous to each another.

21. The device of claim 13, wherein the first insulative layer, the second insulative layer, the bait layer, the first conductive layer, the second conductive layer, the third conductive layer, and the fourth conductive layer define a first terminal portion that extends along the first direction and the second direction and is located adjacent a first end of the strip, and wherein the first insulative layer, the second insulative layer, the bait layer, the first conductive layer, the second conductive layer, the third conductive layer, and the fourth conductive layer define a second terminal portion that extends along the first direction and the second direction and is located adjacent a second end of the strip located opposite the first end, the device further comprising:
a first electrical terminal electrically coupled to at least one of the first conductive layer and disposed within the first terminal portion; and
a second electrical terminal electrically coupled to at least one of the first conductive layer and disposed within the second terminal portion.
